(19) United States
(12) Patent Application Publication
(10) Pub. No.: US 2003/0202207 A1
(43) Pub. Date: Oct. 30, 2003

(54) Device and method for providing image information via a network

(76) Inventor: Hermann Fuchsberger, Ismaning (DE)

Correspondence Address: Karl F. Milde, Jr., Esq., MILDE & HOFFBERG, L.L.P., Suite 460, 10 Bank Street, White Plains, NY, 10606, US

(21) Appl. No.: 10/426,117

(22) Filed: Apr. 29, 2003

(30) Foreign Application Priority Data
Apr. 30, 2002 (EP) 02009751.5

(51) Int. Cl. G06F 15/00; G06K 1/00; H04N 1/00

(52) U.S. Cl. 358/1.15; 358/402

(57) ABSTRACT

A device (WA) and a method for presenting image data assigned to several orders (X1, X2, Y1, Y2, Y3, Z1) from a customer (CU) via a network (N1, N2) are described. The device includes a buffer (SP) to store the image data from the orders (X1, X2, Y1, Y2, Y3, Z1) and a first receiver (URL1) to receive a query (A1) to summon at least one of the orders (X1, X2, Y1, Y2, Y3, Z1). A first network address is assigned to the first receiver (URL1). The first image data are accessed by means of a control device (SM) based on the query (A1) received by the first receiver (URL1). A query (A2) to summon at least one of the orders (X1, X2, Y1, Y2, Y3, Z1) is received by means of a second receiver (URL2), to which a second network address is assigned. The second image data are accessed by means of the control device (SM) based on the query (A2) received by the second receiver (URL2). For this, the first image data include the second image data.

### BACKGROUND OF THE INVENTION

This invention relates to a device and a method for providing image information via a network.

Such a device and such a process are known from U.S. Pat. No. 5,760,916. This patent describes a central Web Album to which several photo-finishing laboratories are connected. A customer may send a photographic order, e.g., a photographic film, to one of the photographic finishing laboratories. The images on the film are scanned, producing digital image data assigned to the scanned film. Specific identification is assigned to the digital image data of the photographic order. The lab subsequently passes the digital image data from the order to the Web Album. The digital image data are stored under the specific identification in the Web Album. The customer can access the digital image data stored in the central Web Album via a telecommunications connection. After establishing a connection between himself and the Web Album, the customer provides the specific identification for his particular photographic order and sends it to the Web Album. After a legitimacy check of the customer, the digital image data are transferred from the Web Album to the customer. In the known system, the customer can transmit his photographic order to any of the photographic finishing laboratories connected to the Web Album. In any case, he can summon his digital image data from the central Web Album, no matter which photographic finishing laboratory accepted his photographic order. He need not know which order he placed with which lab. He selects the network address of the Web Album, and can access the digital image data of the specific photographic order by means of the specific identification of the photographic order transmitted to him earlier. Independent of which lab processed the customer's order, he always accesses the same network address, namely that of the Web Album. Thus, it is possible only with great difficulty for the labs to maintain personal relationships with customers, as was usual in the case where each lab maintained its own, proprietary Web Album. This proprietary Web Album is accessible to the customer at its own network address. The digital image data of the customer's orders processed by each laboratory are accessible via the proprietary Web Album.

### SUMMARY OF THE INVENTION

It is the principal object of the present invention to increase flexibility for the customer and for the photographic finishing laboratory by presentation of image data in a technically simple manner.

According to the invention, there are two receivers to receive a query for access of image data stored in a buffer. The two receivers are accessible via a network using two different network addresses. Depending on which receiver receives the query for access of image data, a controller accesses different data stored in the buffer. The image data on which the query received by the first receiver is based include those image data accessed based on the query received by the second receiver. Moreover, these image data accessed based on the query received by the first receiver may include additional image data. Image data are assigned to various orders of a single customer. These orders may particularly be photographic orders such as processing of photographic images from a negative film. The image data may, for example, contain digital image data from individual images, specific designations for the customer's order, or other things.

The queries to access at least one order received by the first and/or second receiver may particularly be performed by the customer. The customer can establish a telecommunications connection via the network, from his private computer, for example, to the device based on the invention. Via this connection, he may then submit a query to the device to access at least one order. Whether he receives more image data or less image data depends on the network address he uses to communicate to the device based on the invention. If he accesses the network address assigned to the first receiver, he receives more image data than if he accesses the network address assigned to the second receiver.

In an advantageous embodiment of the invention, the device is connected with several image-processing facilities to process the customer's order. This connection may particularly be achieved using a network. These image-processing facilities serve to process the orders submitted to them by the customer. Specifically, they can create digital image data of the pictures contained in the order. After processing the customer orders, the image-processing facilities can transmit image data, particularly digital image data, to the device based on the invention via the connection to the device based on the invention.

In another particularly advantageous embodiment of the invention, the first receiver is assigned to several image-processing facilities, and the second receiver is assigned to one of the several image-processing facilities. Thus, all orders may be processed for the customer who transmits a query to access at least one order to the device based on the invention via the first receiver that were processed by the image-processing facilities connected to this device. If the customer passes a query to the second receiver of the device based on the invention to access at least one order, all orders are presented to this customer that were processed by the image-processing facility assigned to the second receiver. The customer can log in to the device based on the invention using a specific user-ID, and then be presented with all his orders to the extent that this logging-in occurs via the first receiver. If the customer logs in under his specific user-ID to the device based on the invention via the second receiver, only certain orders are presented to him, namely those orders that were processed by a specific image-processing facility assigned to the second receiver. In this configuration of the invention, it is advantageously possible for the image-processing facility to select the network address that is most accessible and distinctive that is different from the one assigned to the first receiver, and that can best service the customer's needs.

It is also possible for the customer to submit an identification number for a specific order instead of, or in addition to, his user-ID. In this case, he may not only be automatically presented with image information about the order whose identification he submitted, but may additionally receive image information regarding all other orders that were presented from all connected image-processing facilities (in case of a transfer of the query to the first receiver), or from only those orders that were processed by one of the image-processing facilities (in the case of a transfer of the query to the second receiver).

In a further advantageous embodiment of the invention, a common buffer is present in which image information assigned to several orders may be stored, whereby these orders were processed by different image-processing facilities. In this manner, image data of an order queried by the customer may be presented quickly and effectively. Expensive transfers of image data, particularly via a network, can largely be avoided. Image data management is possible within the common buffer.

In a further advantageous embodiment of the invention., the control device contains a first and a second summoning device to query image data from the buffer. Summoning image data via the first summoning device is achieved by means of first conditions, and summoning image data via the second summoning device is achieved by means of second conditions. The first conditions are applied when the query to summon image data from the first receiver is received. The second conditions are applied when the query to summon image data from the second receiver is received. The first and second conditions might represent a type of filters that serve to filter out the desired image data from the queried order from the large volume of image data stored in the buffer. Presentation of image data is thus very simply achieved.

The second conditions might include the first conditions. This means that the second conditions contain additional conditions in addition to the first conditions. Certain image data that may be presented based on the first conditions are thus not presented when the second conditions are applied. Image data that thus may be reported based on the second conditions are limited in comparison to image data reported based on the first conditions.

Simplified presentation of image data is possible in that the first and the second conditions contain indicators that refer to specific addresses in the buffer. Thus, quicker access to the desired image data is possible. However, the buffer management must be so organized that it deposits image data in a specific sequence.

For a full understanding of the present invention, reference should now be made to the following detailed description of the preferred embodiments of the invention as illustrated in the accompanying drawings.

### BRIEF DESCRIPTION OF THE DRAWINGS

FIG. 1 is a schematic representation of a first embodiment of the device according to the invention.

FIG. 2 is a schematic representation of a second embodiment of the device according to the invention.

FIG. 3 is an example of buffer organization to store image data.

FIG. 4 is a sample representation of a configuration of several orders from one customer that were processed by various photographic finishing laboratories.

FIG. 5 is a sample representation of a configuration of several customer orders that were processed by a single photographic finishing laboratory.

### DESCRIPTION OF THE PREFERRED EMBODIMENTS

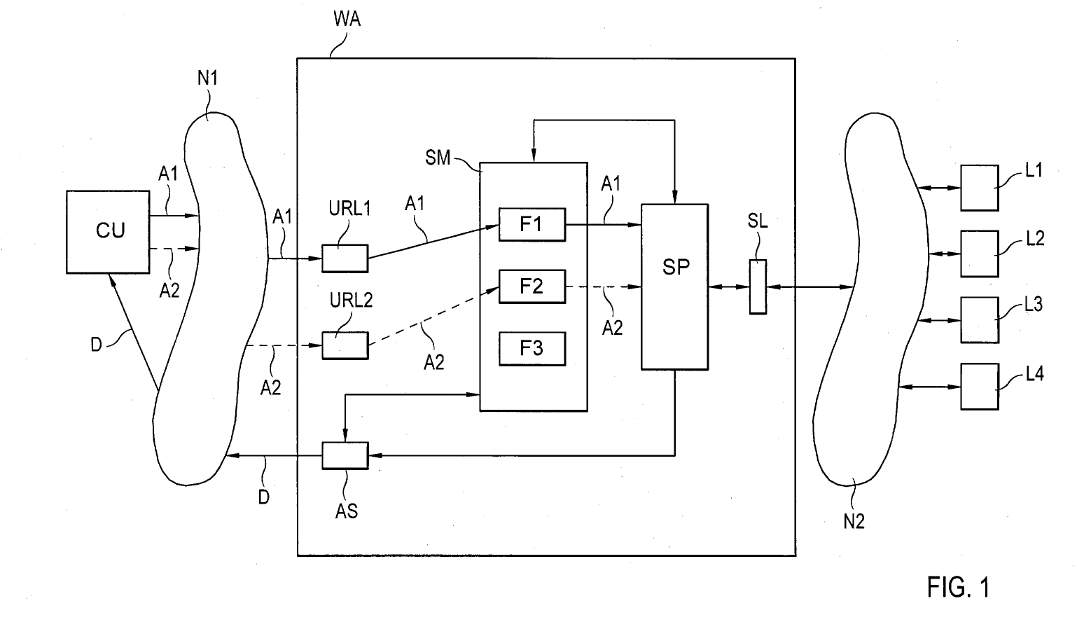

The preferred embodiments of the present invention will now be described with reference to FIGS. 1-5 of the drawings. Identical elements in the various figures are designated with the same reference numerals.

FIG. 1 shows the first embodiment example of the device based on the invention. The device based on the invention here is a Web Album WA and serves to present image data regarding photographic orders to a large number of customers that have been placed with photographic finishing laboratories. The image data made available to the customers are particularly digital image data of those pictures that are contained in the particular order. Image data, i.e., particularly digital image data of the pictures in the order are stored in a buffer SP of the Web Album WA. The buffer SP has a very large capacity to store a very large amount of digital image data. The buffer SP may contain a number of servers that, for example, storing the digital image data on a large number of hard drives. In the embodiment example per FIG. 1, a central buffer SP is located in the Web Album WA. All those photographic finishing laboratories that work together with the operator of the Web Album store the image information that is assigned to the orders that were processed by each photographic finishing laboratory in the buffer SP. In this embodiment example per FIG. 1, four photographic finishing laboratories—laboratories L1, L2, L3, and L4 that collaborate with the Web Album WA are shown.

FIG. 1 shows, for example, a customer CU who has placed one or more orders with one or more of the photographic finishing laboratories L1-L4. Such a photographic order may, for example, be a photographic negative film that is developed and digitally sampled by the selected photographic finishing laboratory L1-L4 in order to create digital image data of the pictures contained on the photographic film. By means of the digital image data thus obtained, each laboratory L1-L4 may produce photographic pictures, for example, using a digital printer. These photographic pictures may be sent to the customer CU by mail, for example. Alternatively or additionally, the digital image data from the selected laboratory L1-L4 may be transferred to the Web Album WA and stored in the buffer SP. Special designation is assigned to the digital image data of each order. Using this special designation, the digital image data of the order may be unambiguously identified.

The customer CU can access the Web Album WA via a first network N1. For this, the customer CU has a computer, for example, with which he may establish a connection via the Internet to the Web Album WA. In this case, the Internet is the first network N1. In order to establish the connection between the customer CU to the Web Album WA, the Web Album WA contains several interfaces to the first network N1. In this embodiment example per FIG. 1, the Web Album WA contains a first interface URL1 and a second interface URL2. However, other interfaces may be present in the Web Album WA. The two interfaces URL1 and URL2 belong to a first or to a second receiver to receive queries for access to image data assigned to photographic orders that the customer CU has placed with one of the laboratories L1-L4. Different network addresses at which they may be addressed are assigned to the receivers URL1 and URL2. Depending on via which receiver ULR1 or URL2 the customer CU would like to establish a connection to the Web Album WA, he inputs the corresponding network address of the desired receiver URL1 or URL2 to his computer's web browser. A connection is then established via the first network N1 from the customer's CU computer to the selected receiver URL1 or URL2. The photographic finishing laboratories L1-L4 are connected to a second network N2 by means of which connections from the laboratories L1-L4 to the Web Album WA may be established. For this, the Web Album WA includes an interface SL to the second network N2.

In this embodiment example, the Web Album WA is connected to the first network N1 and the second network N2. The two networks N1 and N2 may be one and the same network, the Internet for example. It is just as possible, however, for particularly the second network NZ to be configured as an Intranet so that protected data transfer is possible between the photographic finishing laboratories L1-L4 and the Web Album WA. The second network N2 should preferably be so configured that large quantities may be transferred at a high transfer rate. In this manner, it may be ensured that, after the processing of the various orders is completed in the laboratories L1-L4, the digital image data of each order may be transferred very quickly from the laboratories L1-L4 to the Web Album WA. Instead of a central buffer SP to store all image data assigned to orders processed by laboratories L1-L4, another buffer with significantly smaller storage capacity than that of the buffer SP may be used within the Web Album WA. This other buffer then serves to compile the image data queried by the customer CU. It is then not necessary to store all the image data from all the orders processed by the laboratories L1-L4 in this other buffer within the Web Album WA. Decentralized storage of these image data may occur at the laboratories L1-L4. This means that the laboratories L1-L4 include buffers in which they store image data assigned to the orders processed by them. In order to compile the orders queried by the customer CU, the queried image data must be transferred on short notice from the laboratories L1-L4 to the other buffer provided within the Web Album WA.

The Web Album WA includes a control device SM that controls the management of the buffer SP and of access to the buffer SP. The control device SM converts the customer download queries received by the receivers URL1 and URL2 in such a manner that the image data stored in the buffer SP that are assigned to the queried orders may be accessed. For this, the control device SM contains several filters that contain specific conditions that specify in detail the image data that may be accessed. In this embodiment example based on FIG. 1, the control device receives a first filter F1, a second filter F2, and a third filter F3. It is possible for the control device SM to contain additional filters. The first filter F1 is assigned to the first receiver URL1, and the second filter F2 is assigned to the second receiver URL2. This means that all customer queries received from the first receiver URL1 are then passed to the first filter F1, and all customer queries received from the second receiver URL2 are then passed to the second filter F2. For this, the first receiver URL1 is connected with the first filter F1, and the second receiver URL2 is connected with the second filter F2. The third filter F3 may, for example, be connected with another receiver of the Web Album WA, not shown in FIG. 1.

In this embodiment example based on FIG. 1, the customer CU submits a first query A1 and a second query A2 to the Web Album WA to download photographic orders. For the first query A1, he selects the address of the first receiver URL via his Internet browser. A connection is established between the customer CU and the first receiver URL1via network N1. The query A1 may, for example, contain specification of a particular designation of a particular photographic order. This designation was transmitted to the customer CU previously either from the laboratory L1-L4 that processed the photographic order, or from the Web Album WA. This transmission of the designation of the photographic order may be by e-mail, for example. Instead of, or in addition to, the input of a special designation for a specific photographic order, the customer CU may also input his personal user ID upon submission of the query Al to the Web Album WA.

The first receiver URL1 and the first filter F1 here are assigned to all of the photographic finishing laboratories L1-L4 connected to the Web Album WA. This means that image data from the Web Album WA that are assigned to all orders that the customer CU placed with one of the laboratories L1-L4 connected to the Web Album WA are presented to the customer CU who selected the first receiver URL1. The filter F1 is thus so configured that it contains conditions by means of which image data of all orders stored in the buffer SP from the customer CU by means of the control unit SM. A selection of orders that were processed only by specific laboratories L1-L4 results from access to the buffer SP via the first filter F1.

With the second query A2, the customer CU establishes a connection to the second receiver URL2. This second receiver URL2 is assigned to only one of laboratories L1-L4 that is connected to the Web Album WA. In this embodiment example, the second receiver URL2 and the filter F2 are assigned to the second laboratory L2. The filter F2 therefore contains such conditions that, upon receiving the query A2 through the second receiver URL2, the control device SM accesses image information stored in the buffer SP of those orders that were processed for the customer CU by the second laboratory L2. The orders processed for the customer CU from the other laboratories L1, L3, and L4 are not presented.

The control device SM controls the composition of the image data to be presented to the customer CU, as well as its output via the output interface. In order to present the image data that the control device SM accessed based on the query A1 or A2, the Web Album WA contains an output interface AS that is connected with the first network N1. The image data presented may be transferred to the customer CU via the network N1 from the output interface AS of the Web Album WA via an established connection D.

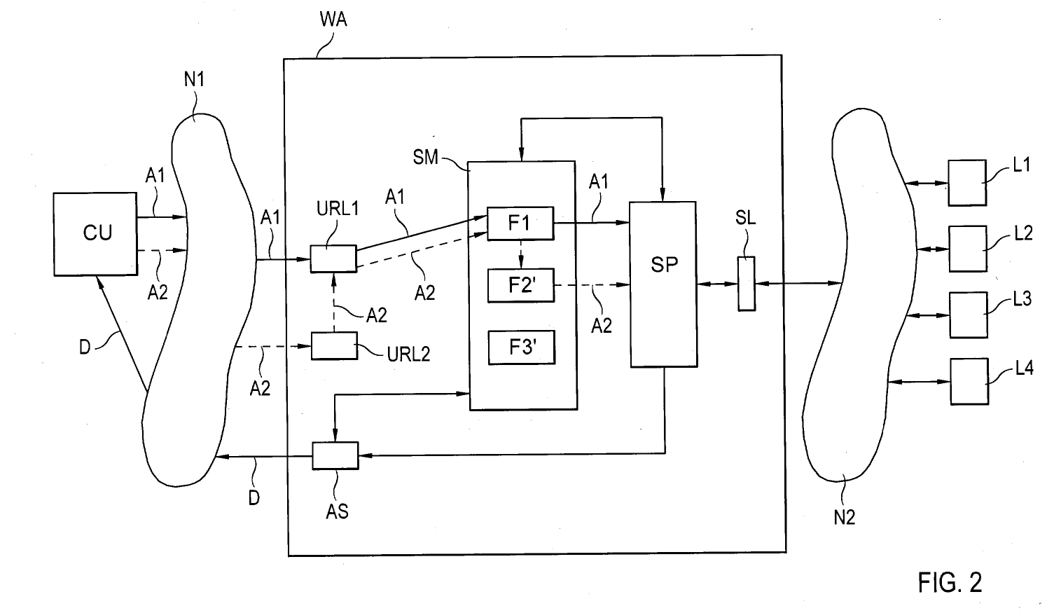

FIG. 2 shows a schematic representation of the second embodiment example of the Web Album WA based on the invention. The structure of the Web Album WA according to the second embodiment example largely corresponds to that of the first embodiment example. However, the further transmission of the second query A2 within the Web Album WA is implemented differently. Even the structure of the filters used to access specific image data of the buffer SP within the control device SM of the Web Album WA per the second embodiment example is different. Instead of the filters F2 and F3 in the first embodiment example, the control device SM in the second embodiment example contains the filters F2′ and F3′.

In the second embodiment example, the structure of the filter F1 largely corresponds to that of the first embodiment example. The filter F1 also contains such conditions that allow access to all image data assigned to the customer's CU order. That means that filter F1 filters out all image data stored in the buffer SP and assigned to such orders placed with the photographic finishing laboratories L1-L4 by other customers, and not by the customer CU.

In contrast to the first embodiment example in which the filter F2 includes the conditions of the filter F1, the filter F2′ of the control device SM contains only those conditions that allow filtering out of image data that were processed by a specific photographic finishing laboratory, i.e., here laboratory L2. The same applies for the filter F3′ that is assigned to another single photographic finishing laboratory, e.g., laboratory L3.

If, according to the second embodiment example, a second query A2 directed by the customer CU to the Web Album WA is received by the second receiver URL2, then the second receiver URL2 routes this second query A2 to the first receiver URL1. In the Web Album WA of the second embodiment example, a further routing of all queries arriving at the second receiver URL2 to the first receiver URL1 is thus implemented. The second receiver URL2 thus does not have its own connection to the control device SM in order to route the queries received by the second receiver URL2 to the control device SM. Routing of queries sent to the Web Album WA to summon orders is routed to the control device SM exclusively by the first receiver URL1. All queries Al and A2 thus pass through the first filter F1, through which all orders are specified that were placed by the customer CU with one of the laboratories L1-L4. The first query Al directed to the first receiver URL1 passes through the filter F1 exclusively, so that the customer CU may be presented with image data from all his orders processed by laboratories L1-L4 based on his first query A1. The second query A2 is additionally passed on to the filter F2 after passing through the first filter F1. This has the effect that, in addition to that image data specified by the filter F1, image data from all orders of the customer CU are selected by the filter F2′ that were processed by the laboratory L2. Thus, the combination of the filter F1 and F2′ here are assigned to the second laboratory L2. The filter F1 is assigned to all of the laboratories L1-L4, as was the case in the first embodiment example.

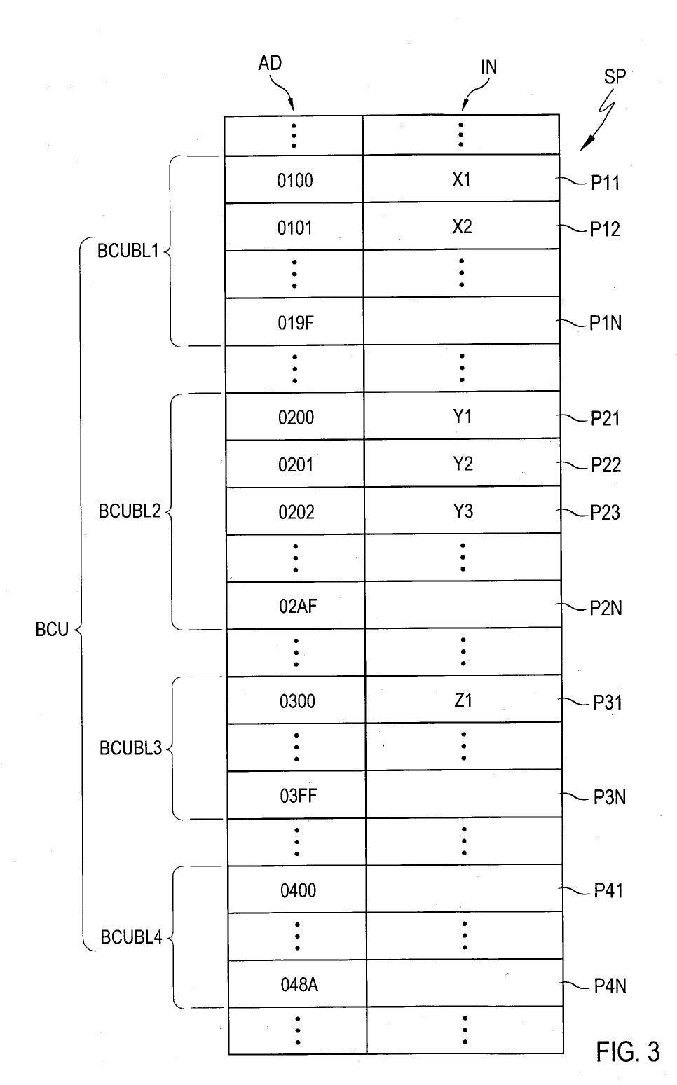

FIG. 3 shows an example of an organization plan for the buffer SP as it may be implemented within a Web Album WA in accordance with the first or second embodiment examples. The buffer SP in FIG. 3 here contains two buffer areas arranged as adjacent columns in FIG. 3. Buffer addresses are in a first buffer area AD. A second buffer area contains image data assigned to specific orders. The image data are stored in individual fields of the second buffer area IN. In the example illustrated in FIG. 3, the address 0100 is assigned to a first field P11. The first field P11 contains image data assigned to a first order X1. The address 0101 is assigned to a second field P12. The second field P12 contains image data assigned to a second order X2. The address 019F is assigned to a field P1N. This field is empty, and does not contain image data from an order. Image data of an order Y1 are stored in another field P21. The buffer address 0200 is assigned to this field P21. Field P22 contains image data of another order Y2. The buffer address 0201 is assigned to this field P22. Field P23 contains stored image data of an order Y3. The buffer address 0202 is assigned to the field P23. A field P2N does not contain image data of an order. The buffer address 02AF is assigned to the field P2N. The buffer address 0300 is assigned to the field P31. A field P3N is also empty, and contains no image data. The buffer address 03FF is assigned to this field P3N. The buffer address 0400 is assigned to this field P41, and buffer address 048A is assigned to the field P4N. Both fields P41 and P48A are empty, and contain no image data. According to the example in FIG. 3, the buffer SP contains a large number of additional fields that are not shown in detail in FIG. 3. For example, there are fields between the fields P12 and P1N, and between the fields P23 and P2N, and between fields P31 and P3N, and between the fields P41 and P4N, to which their own buffer addresses are assigned.

The buffer SP is so organized that specific fields, which are preferably positioned adjacent within the buffer SP, are assigned to specific customers, here especially customer CU, and to specific photographic finishing laboratories L1-L4. This means that these fields are reserved for the customers and for the photographic finishing laboratories. In this example per FIG. 3, the fields assigned to the buffer addresses 0100-019F, are assigned to the customer CU and to the first laboratory L1. The fields that belong to buffer addresses 0200-02AF are assigned to the customer CU and to the second laboratory. The fields with buffer addresses 0300-03FF are assigned to the customer CU and to the third laboratory, and the fields with buffer addresses 0400-038A are assigned to the customer CU and to the fourth laboratory. This means that such image data are stored in the fields assigned to the customer CU and the first laboratory L1 that were assigned to orders placed by the customer CU with the first laboratory L1. Such image data are stored in the fields assigned to the customer CU and the second laboratory L2 that were assigned to orders placed by the customer CU with the second laboratory L2. The fields of the buffer SP assigned to the customer CU and the third laboratory L3 are used to store image data assigned to orders placed by the customer CU with the third laboratory L3. And the image data are stored in the fields assigned to the customer CU and the fourth laboratory L4 that were assigned to orders placed by the customer CU with the fourth laboratory L4.

The information stored in the first-named fields may be accessed by means of a condition BCUBL1. The information stored in the second-named fields may be accessed by means of a condition BCUBL2. The information stored in the third-named fields may be accessed by means of a condition BCUBL3. The information stored in the fourth-named fields may be accessed by means of a condition BCUBL4. All fields in which image data from customer CU are stored may be accessed using condition BCU. Therefore, in order to access all image data from orders from customer CU, the filter F1 contains the condition BCU. Access to all image data assigned to orders from the customer CU that he placed with the second laboratory L2 results from the condition BCUBL2. In the case of the first embodiment example, in which the second receiver URL2 directly controls the filter F2, the filter F2 contains the condition BCUBL2. In the case of the second embodiment example, in which the query A2 first passes through filter F1 and subsequently through filter F2′, the filter F2′ contains the condition BL2. The combination of the filters F1 and F2′ as in the second embodiment example thus leads to the joint condition BCUBL2.

For the sake of simplicity, the fields with the image data to be presented may be controlled via indicators that point to the corresponding buffer addresses. The filters of the control device SM may thus contain such indicators. While the query is passed through the filter F2 in the first embodiment example, the control device SM accesses the buffer addresses 0200-02AF, in which image data from orders from the customer CU may be stored that are assigned to orders that he/she placed with the second laboratory L2.

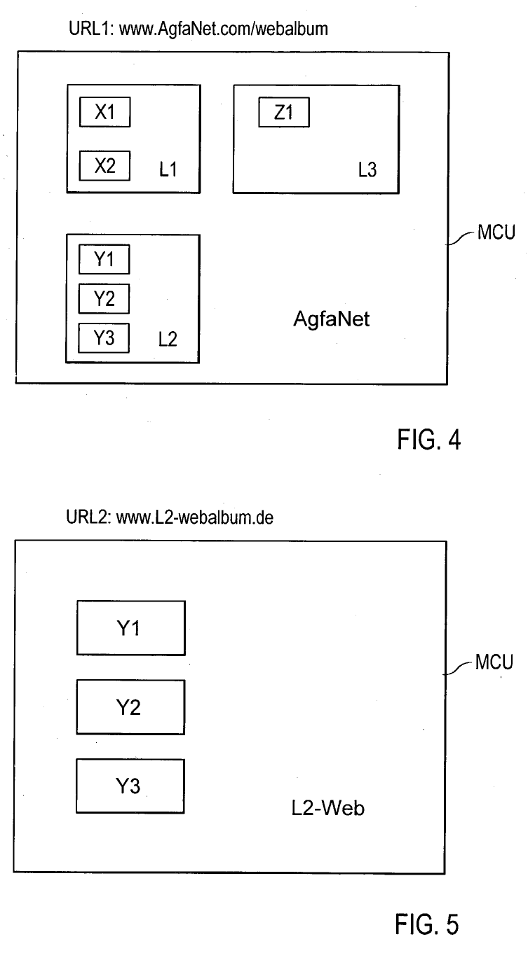

FIG. 4 shows a sample representation of a composition of several orders from customer CU performed by the control device SM that were processed by the laboratories L1, L2, and L3. The composition as in FIG. 4 was transmitted to the customer CU via the first network N1 and the output interface AS of the Web Album WA. The composition here is displayed on the customer's monitor MCU. It was compiled based on the query A1 from the customer CU. For this, the customer CU submitted the query A1 to the first receiver URL1 of the Web Album WA. For this, the customer input the addresses of the first receiver URL1 into his computer Web Browser. The address of the first receiver URL1 is given in the example in FIG. 4 as www.Agfa-net.com/web-album. This is how a connection was established to the Web Album WA.

After input of the special user-ID of the customer CU, the query A1 passed through the filter F1. The control device SM was able to access the buffer SP and to identify all image data of those orders that were placed by the customer CU with one of the laboratories L1-L4. In this example, this is the image data from orders X1 and X2 that were processed by the first laboratory L1, and the image data from orders Y1, Y2, and Y3 that were processed by the second laboratory L2. Further, the control device SM identified the image data of order Z1 that was processed by the third laboratory. The image data created by the various laboratories L1, L2, and L3 from various orders are represented in the compilation by laboratory per FIG. 4. These image data may be, for example, specific titles or titles of each individual order. It is also possible that so-called thumbnail views are shown in the compilation. Such thumbnails are low-resolution reproductions of the photographs contained in each order. All images contained in the order may be transmitted to the customer CU in low-resolution form, for example. It is also conceivable to transfer to the customer CU directly the complete high-resolution digital image data of the photographs contained in the order.

After transmission of the compilation, the customer CU may identify specific photographs or a complete set of all photographs in an order, from which photographic prints in the form of extracts are to be produced in one of the photographic finishing laboratories. In this manner, the customer may compile a new order that is transmitted to one of the photographic finishing laboratories L1-L4 via the Web Album WA to produce the photographic prints. It is advantageously possible that he may select images from several orders and combines them into a new order. The selected images may thus stem from orders that were previously placed with various laboratories. For example, an image from the order X1 that was placed with laboratory L1 may be combined with an image from order Y2 that was placed with laboratory L2 to form a new order. This new order would then be passed to the Web Album WA. The Web Album WA could then distribute the order for the photographs that stem from various orders into several partial orders. This means, for example, that the photograph from the new order that stems from order X1 may be sent to the laboratory L2. The photograph from the new order that stems from order Y2 is sent to the laboratory L2. Alternatively, it is just as possible that the Web Album WA routes the complete new order to one of the photo finishing laboratories L1-L4 so that it may process the entire order. The customer CU may then specify the laboratory to which the new order is sent. For combined processing of the entire order in one laboratory, it may be necessary, depending on the storage of the complete image data of the individual photographs of the new order, to transfer image data of individual photographs that are stored at other laboratories or in the Web Album WA buffer to the laboratory.

FIG. 5 shows another advantageous representation of a compilation of several orders from the customer CU. The compilation per FIG. 5 thus exclusively contains image data from those orders that were processed by the second laboratory L2. The customer CU thus has sent the query A2 to the second receiver URL2 of the Web Album WA. For this, he selected the network address www.L2-Web-Album.de that is assigned to the second receiver URL2. As described above, the control device SM identifies the image data from those orders that the customer CU had previously placed with the second laboratory L2 by means of the filter F2 (first embodiment example), or by means of the combination of the filters F1 and F2′ (second embodiment example). In this case, this is the image data from orders Y1, Y2, and Y3.

The compilation per FIG. 5 is transmitted to the customer CU via the output interface AS and the first network N1. This compilation may then be displayed on the computer monitor MU of the customer CU. As was previously described in connection with FIG. 4, the customer may select specific images from the orders Y1-Y3 and compile them into a new order that may be passed via the Web Album WA to the one of the laboratories L1-L4 to produce photographic prints.

There has thus been shown and described a novel device and method for providing image information via a network which fulfills all the objects and advantages sought therefor. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

What is claimed is:

1. In a device (WA) for presenting image data assigned to a plurality of orders (X1, X2, Y1, Y2, Y3, Z1) from a customer (CU) via a network, said device comprising, in combination:
(a) a buffer (SP) to store image data from the plurality of orders (X1, X2, Y1, Y2, Y3, Z1);
(b) a first receiver (URL1), responsive to a first network access address, for receiving a first query (A1) to summon at least one order (X1, X2, Y1, Y2, Y3, Z1);
(c) a second receiver (URL2); responsive to a second network access address, for receiving a second a query (A2) to summon at least one order (X1, X2, Y1, Y2, Y3, Z1); and
(d) a control device (SM) for accessing first image data based on the first query (Al) received by the first receiver (URL1) and accessing second image data based on the second query received by the second receiver (URL2);
wherein the first image data include the second image data.

2. The device defined in claim 1, wherein the device is connected with a plurality of image-processing facilities (L1-L4) via the network (N1, N2) to process orders (X1, X2, Y1, Y2, Y3, Z1) from a customer (CU).

3. The device defined in claim 2, wherein the first receiver (URL1) is assigned to said plurality of image-processing facilities (L1-L4), and the second receiver (URL2) is assigned to one of said plurality of image-processing facilities (L1-L4).

4. Device defined in claim 2, wherein image data assigned to a plurality of orders (X1, X2, Y1, Y2, Y3, Z1) that were processed by various image-processing facilities (L1-L4) are stored in a common storage device (SP).

5. The device defined in claim 4, wherein the control device (SM) includes a first summoning means (F1) to summon image data stored in the buffer (SP) by means of a first set of conditions (BCU) and a second summoning means (F2) to summon image data stored in the buffer (SP) by means of a second set of conditions (BCUBL1, BCUBL2, BCUBL3), and wherein the first summoning means (F1) is assigned to the first receiver (URL1) and the second summoning means (F2) is assigned to the second receiver (URL2).

6. The device defined in claim 5, wherein the second set of conditions (BCUBL1, BCUBL2, BCUBL3) include the first set of conditions (BCU).

7. The device defined in claim 5, wherein the first set of conditions (BCU) and the second set of conditions (BCUBL1, BCUBL2, BCUBL3) include indicators that are assigned to specific addresses (AD) of the buffer (SP).

8. In a method for presenting image data assigned to several orders (X1, X2, Y1, Y2, Y3, Z1) of one customer (CU) via a network, said process comprising the steps of:
(a) storing image data from the orders (X1, X2, Y1, Y2, Y3, Z1) in a buffer storage device (SP);
(b) receiving a query (A1) to summon at least one order (X1, X2, Y1, Y2, Y3, Z1) by a first receiver (URL1), to which a first network access address is assigned; and
(c) accessing the first image data by means of a control device (SM) based on the query (A1) received by the first receiver (URL1);
the improvement comprising the steps of:
(d) receiving a query (A2) to summon at least one order (X1, X2, Y1, Y2, Y3, Z1) via a second receiver (URL2), to which a second network access address is assigned; and
(e) accessing second image data by means of said control device (SM) based on the query (A2) received by the second receiver (URL2);
wherein the first image data include the second image data.
